(19) United States
(12) Patent Application Publication
(10) Pub. No.: US 2008/0158396 A1
(43) Pub. Date: Jul. 3, 2008

(54) Image Signal Processor For CMOS Image Sensors

(75) Inventors: Eugene Fainstain, Netanya (IL); Artyon Tonkikh, Rehovot (IL); Yoav Lavi, Raanana (IL)

Correspondence Address: HARNESS, DICKEY & PIERCE, P.L.C., P.O. Box 8910, Reston, VA, 20195, US

(73) Assignee: TransChip, Inc., Ramat - Gan (IL)

(21) Appl. No.: 11/835,275

(22) Filed: Aug. 7, 2007

Related U.S. Application Data
(60) Provisional application No. 60/821,689, filed on Aug. 7, 2006.

(51) Int. Cl. H04N 9/64

(52) U.S. Cl. 348/246; 348/E09.037

(57) ABSTRACT

A method for enhancing an image read from an image sensor in the digital domain includes analyzing a row or a column of the image; determining the row or column is defective; and replacing the row or the column with information from adjacent portions of the image when the row or image is found defective.

### CROSS-REFERENCES TO RELATED APPLICATIONS

This application is a non-provisional, and claims the benefit, of commonly assigned U.S. Provisional Application No. 60/821,689, filed Aug. 7, 2006, entitled “Image Signal Processor For CMOS Image Sensors,” the entirety of which is herein incorporated by reference for all purposes.

This application is related to the following co-pending, commonly-assigned U.S. patent applications, the entirety of each of which being herein incorporated by reference for all purposes: U.S. patent application Ser. No. 10/474,798, filed Oct. 8, 2003, entitled “CMOS Imager For Cellular applications And Methods Of Using Such”; U.S. patent application Ser. No. 10/474,275, filed Feb. 11, 2005, entitled “CMOS Imager For Cellular applications And Methods Of Using Such”; U.S. patent application Ser. No. 10/474,799, filed Oct. 8, 2003, entitled “Built-In Self Test For A CMOS Imager”; U.S. patent application Ser. No. 10/474,701, filed Oct. 8, 2003, entitled “Serial Output From A CMOS Imager”; U.S. patent application Ser. No. 10/333,942, filed Apr. 29, 2003, entitled “Single Chip CMOS Image Sensor System With Video Compression,” which is a non-provisional, and claims the benefit, of U.S. Provisional application No. 60/231,778, filed Sep. 12, 2000, entitled “CMOS Image Sensor With Integrated Motion Estimation Accelerator”; U.S. patent application Ser. No. 11/101,195, filed Apr. 6, 2005, entitled “Methods And Systems For Anti Shading Correction In Image Sensors,” which is a non-provisional, and claims the benefit, of U.S. Provisional application No. 60/560,298, filed Apr. 6, 2004, entitled “Anti Shading Correction For CMOS Imagers Methods And Circuits”; U.S. patent application Ser. No. 11/107,387, filed Apr. 14, 2005, entitled “Systems And Methods For Correcting Green Disparity In Imager Sensors,” which is a non-provisional, and claims the benefit, of U.S. Provisional Application No. 60/562,630, filed Apr. 14, 2004, entitled “Green Disparity Corrections For CMOS Imagers Methods And Circuits”; U.S. patent application Ser. No. 11/223,758, filed Sep. 9, 2005, entitled “Imager Flicker Compensation Systems And Methods,” which is a non-provisional, and claims the benefit, of U.S. Provisional Application No. 60/609,195, filed Sep. 9, 2004, entitled “Imager Flicker Compensation”; U.S. patent application Ser. No. 11/467,044, filed Aug. 24, 2006, entitled “Smear Correction In A Digital Camera,” which is a non-provisional, and claims the benefit, of U.S. Provisional Application No. 60/711,156, filed Aug. 24, 2005, entitled “Methods And Apparatus For Smear Correction In A Digital Camera; U.S. patent application Ser. No. 11/674,719, filed Feb. 14, 2007, entitled “Post Capture Image Quality Assessment,” which is a non-provisional, and claims the benefit, of U.S. Provisional Application No. 60/773,400, filed on Feb. 14, 2006, entitled “Post Capture Image Quality Assessment; U.S. patent application Ser. No. 11/683,084, filed Mar. 7, 2007, entitled “Low Noise Gamma Function In Digital Image Capture Systems And Methods,” which is a non-provisional, and claims the benefit, of U.S. Provisional Application No. 60/780,130, filed on Mar. 7, 2006, entitled “Low Noise Gamma Function”; and U.S. patent application Ser. No. 11/686,632, filed Mar. 15, 2007, entitled “Low Noise Color Correction Matrix Function In Digital Image Capture Systems And Methods,” which is a non-provisional, and claims the benefit, of U.S. Provisional Application No. 60/782,502, filed Mar. 15, 2006, entitled “Low Noise Color Correction Matrix Function.”

### FIELD OF THE INVENTION

Embodiments of the present invention relate generally to image capture. More specifically, embodiments of the invention relate to systems, circuits, and methods for processing image sensor signals.

### BACKGROUND OF THE INVENTION

The desire for higher quality image capture capability in a smaller form factor is driving a need for every-increasing improvements in space and time efficiency. For example, it is desirable to have improved image signal processing on pixel outputs comprised by a pixel stream being output from an image array (e.g., a CMOS image sensor array). Ideally, such processing would be accomplished with limited or no need for interim pixel storage or buffering, would correct or modify a number of image properties to thereby, for example, correct image aberrations, would adjust image size and appearance, would convert the raw pixel output into any of a number of video standards, and the like. Moreover, such image signal processing would consume little power and could be implemented using minimal silicon area. Embodiments of the present invention address these and a number of shortcomings of the prior art.

### BRIEF SUMMARY OF THE INVENTION

Embodiments of the present invention provide a method for enhancing an image read from an image sensor in the digital domain. The method includes analyzing a row or a column of the image; determining the row or column is defective; and replacing the row or the column with information from adjacent portions of the image when the row or image is found defective.

Further embodiments provide a method for enhancing an image read from an image sensor in the digital domain. The method includes determining first columns read from one side of the image sensor; determining second columns read from an opposite side of the image sensor; applying a first correction to the first columns, whereby variance through the column is addressed in the digital domain for the first columns; and applying a second correction to the second columns, whereby variance through the column is addressed in the digital domain for the second columns.

Still further embodiments provide a method for enhancing an image read from an image sensor in the digital domain. The method includes reading a red-green row or column from the image sensor. The red-green row or column is part of a Bayer image. The method also includes discarding the red-green row or column from the Bayer image; and processing the image by beginning with a green-blue row or column.

Still further embodiments provide a method for enhancing an image from an image sensor. The method includes performing a horizontal interpolated RGB function; performing a vertical interpolated RGB function; determining if a portion of the image has a vertical edge or a horizontal edge; and choosing either the horizontal interpolated RGB function or the vertical interpolated RGB function based upon the determining step.

Further embodiments provide a method for enhancing an image from an image sensor. The method includes gamma correcting a first image in the Bayer domain to produce a second image; demosaicing the second image to produce a third image; and inverse-gamma correcting the third image to produce a fourth image. The method may include sharpening the third image before the inverse-gamma correcting step.

Even further embodiments provide a method for enhancing an image from an image sensor. the method includes gathering a matrix of green pixels in the Bayer domain; determining if a periodic pattern appears in the matrix; and correcting green disparity according to the periodic pattern. The correcting step may be performed during normal operation of the image sensor.

Further embodiments provide a method for enhancing an image from an image sensor. The method includes providing a RGB vector; categorizing a CMY color wheel into a plurality of slices, wherein each slice has a color correction matrix; determining which slice corresponds to the RGB vector; and applying the color correction matrix for the slice corresponding to the RGB vector.

Other embodiments provide a method for enhancing an image from an image sensor. The method includes analyzing a cluster of pixels in the image; determining the cluster is defective in some way; replacing the cluster with information from adjacent portions of the image when the cluster is found defective.

Still further embodiments provide an image processing method for correcting photo response non-uniformity in an image sensor. The method includes storing an approximation function of the photo response non-uniformity across the image sensor; and using the approximation function to calculate corrections factors to correct the photo response non-uniformity of the image sensor. In some embodiments the approximation function is a 2-dimensional polynomial of the nth order. The approximation function may be a 2-dimensional polynomial of the 3rd order. The method may include scanning the image sensor in a known order; and iteratively calculating the correction factors across the image sensor.

Further embodiments provide a method for enhancing an image from an image sensor. The method includes determining if a pixel is unusually hot or cold in comparison to neighboring pixels; discarding the pixel based upon an outcome of the determining step; and determining a replacement pixel for the pixel based upon an outcome of the determining step.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 depicts a block diagram of an embodiment of a novel image signal processor according to embodiments of the present invention.

FIG. 2 depicts a block diagram of initial Bayer domain processing which may be done to the incoming pixel stream.

FIG. 3 depicts a block diagram of further Bayer domain processing which may be done to the pixel stream after said initial processing.

FIG. 4 depicts a block diagram of Bayer to RGB conversion according to some embodiments of the present invention.

FIG. 5 depicts a block diagram of RGB and YUV processing which may be done to the pixel stream which after it is converted to RGB domain.

FIG. 6 depicts a block diagram of embodiments of Video Format Converters.

FIG. 7 depicts the X-part of embodiments of the present invention.

FIG. 8 depicts the Y-part of embodiments of the present invention.

FIG. 9 depicts an embodiment in which each adder gets a pair of multiplexers on each of its inputs.

FIG. 10 illustrates how surface function can be implemented according to certain embodiments of the present invention.

FIG. 11 depicts a block diagram of Periodic Mismatch correction according to some embodiments of the present invention.

FIG. 12 illustrates the core of the conversion from Bayer to RGB according to embodiments of the present invention.

FIGS. 13A and 13B illustrate the 5×5 neighborhood of a i) Green pixel in a Red line, and ii) Blue pixel in a Blue line.

FIG. 14 illustrates a step in the generation of Blurred Luminance, which is a part of the Bayer to RGB conversion.

FIG. 15 depicts a block diagram of an embodiments of a Blurred Luminance calculator.

FIG. 16 depicts an alternative embodiment of a Blurred Luminance calculator.

### DETAILED DESCRIPTION OF THE INVENTION

Embodiments of the present invention relate to capturing images. In order to provide a context for describing embodiments of the present invention, embodiments of the invention will be described herein with reference to digital image capture. Those skilled in the art will appreciate, however, that other embodiments are possible. The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It is to be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems may be shown in block diagrams in order not to obscure the embodiments in unnecessary detail. In other instances, well-known processes, structures and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Embodiments of the present invention provide image processing methods and/or circuits that implement the methods. These methods are applied to a pixel stream generated by, for example, a CMOS image sensor. The methods convert the raw output of the image sensor into one of several standard video standards. They correct a number of image aberrations, and/or adjust the size and the appearance of the image to better suit the taste of the user and the display device. According to exemplary embodiments, the hardware and/or firmware that implements the methods described herein are optimized for mobile, low-cost implementations featuring low power consumption and small silicon area.

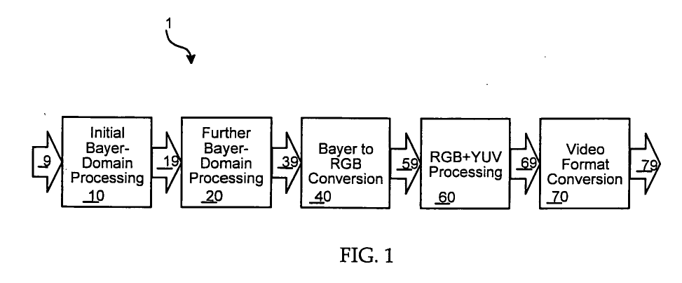

Having described embodiments of the invention generally, attention is directed to FIG. 1 for a more specific discussion of embodiments of the invention. FIG. 1 depicts a block diagram 1 of embodiments of the invention and includes Initial Bayer Processing 10, Further Bayer Processing 20, Bayer to RGB Conversion 40, RGB+YUV Processing 60, and Video Format Conversions 70. These functional blocks will be described in greater detail hereinafter.

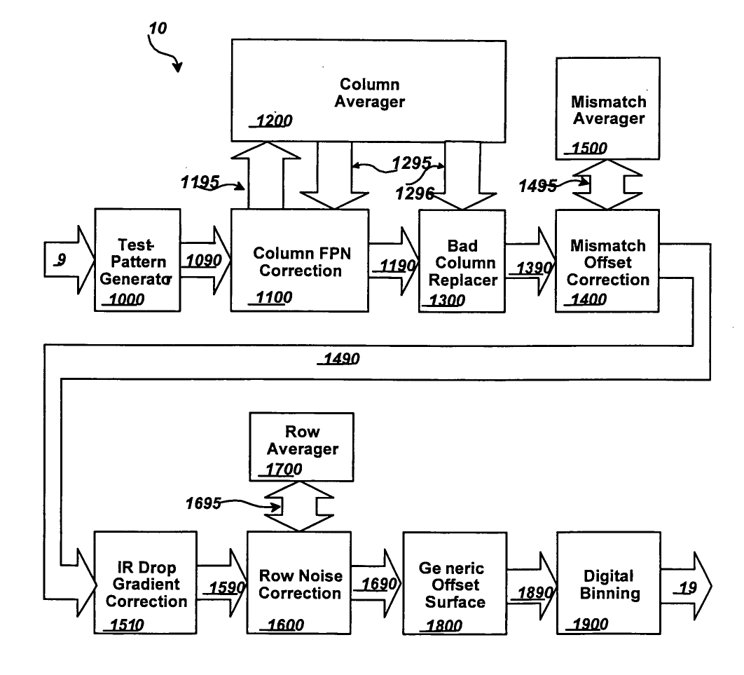

FIG. 2 depicts a block diagram of Initial Bayer-Domain Processing 10 in greater detail. Incoming data from image sensor array (not shown), asserted on bus 9, enters Test-Pattern-Generator 1000, which may be configured by a central control unit (not shown) to either i) pass incoming pixel stream to its output bus 1090, or ii) disregard incoming pixel stream 9 and, instead, drive bus 1090 with a certain programmable test pattern, or with one of several programmable test patterns.

Pixel stream on bus 1090 from test Pattern generator 1000 is input to Column fixed pattern noise (FPN) Correction unit 1100, for column FPN measurement and Correction. Column FPN Correction 1100 sends the values of the input pixels of a first group of pixel lines which are not part of the displayed image, through bus 1195, to Column Averager 1200, which averages the black levels of all columns, and generates a black-level correction value for each pixel to be read according to the measured average for the corresponding column. Column Averager 1200 then sends such correction values via bus 1295 to Column FPN Correction 1100. Column Averager 1200 also sends the correction values via bus 1296 to Bad Column Replacer 1300.

Column FPN Correction 1100 subtracts the black level of the corresponding column according to information received on bus 1295, from each of the incoming pixels, to generate a column-FPN corrected pixel stream 1190, which is then presented at the input of Bad Column Replacer 1300.

Bad Column Replacer 1300 may get the black level for each column from Column Averager 1200, through bus 1296. It then determines if a particular column is defective, for example, by comparing the value of the average dark level for each column to a value which may be the overall dark level average of all columns, plus a programmable threshold. Said threshold may be defined by an absolute voltage level, by a proportion from the average dark level, or by a combination thereof.

Another embodiment determines a column is bad by analyzing calibration dark pixels and calibration direct pixels. The calibration dark pixels are shielded from incident radiation to identify the black level of the image. One embodiment has eight rows of calibration dark pixels spread throughout the imaging array. The calibration direct pixels do not measure incident light, but are directly fed current in a calibrated amount. One embodiment has a column of calibration direct pixels. Column amplifiers can be calibrated based upon a reading of the dark and direct pixels to determine the useful range. A few columns may exceed the margin of the column amplifier. These columns can be replaced rather than changing the useful range of the remaining column amplifier.

When Bad Column Replacer 1300 determines that a particular column is defective, it replaces the value of each of the pixels which constitute said defective column, by a corrected pixel value, which is then merged with the pixel stream of good columns and output on bus 1390. In one embodiment, the bad column is replaced by an interpolation of neighboring columns. The bad column may result from any number of problems, for example, a bad column amplifier.

The corrected pixel value for a column to be replaced may be derived by interpolating the values of those neighbor pixels which have the same type of color filter as that of the pixel in said defective column. In other embodiments of the present invention, the corrected pixel value may be derived by interpolating the values of neighboring pixels which are covered by a color filter of a type different from that of the pixel covering said defective-column pixel, with the value of the neighbor pixels scaled in order to compensate for the color spectrum in the vicinity of the defective column pixel.

Pixel stream from Bad Column Replacer 1300, asserted on bus 1390, is input to Mismatch Offset Correction 1400, which corrects the pixel stream for mismatch in circuit elements which are identical by design, and said mismatches occur from imperfections of the semiconductor process.

In order to correct for mismatch, Mismatch Offset Correction 1400, sends incoming pixels from groups of circuit elements, where units of each groups are identical by design, through bus 1495, to Mismatch Averager 1500, which averages the pixels from each such group to derive the mismatch value for each group. Mismatch Averager 1500 then send this information on bus 1495 back to Mismatch Offset Correction 1400, which, in turn, will correct each pixel according to such correction data, and send the corrected pixel values out on bus 1490.

Pixel stream on bus 1490 next enters IR-Drop Gradient Correction 1510, where the pixel stream is corrected for IR drops which may occur on the pixel signal paths and/or the supply lines. As those skilled in the art appreciate, the IR-drop is a reference to the voltage drop attributable to the resistance at a particular current. The IR-drop varies from the first pixel read in a column to the last in the column.

In this embodiment, even columns are read upwards and odd columns are read downwards because the column amplifier takes the space of two pixel columns. The odd columns have their amplifier on top of the array and the even columns have their amplifier on bottom. The IR-Drop Gradient Correction 1510 corrects the pixel stream by taking into account whether the column is read from on top or on bottom. This correction is done algorithmically in the digital domain, for example, the IR-drop may be considered linear from the first to the last pixel read from the array. In one embodiment, a dark calibration pixel rows are at the top of the image sensor. By determining the difference between the readings in the first and last dark calibration pixels read for each column, the correction differential can be determined. Algorithms, such a linear interpolation, can be used to correct all the pixels in the column. Calibration can be done on the fly by re-analyzing each column, but other embodiments can do the analysis at some prior time and reuse the correction parameters.

Some embodiments have a gain variance over the column. The pixels at the top of the column may be more sensitive than those at the bottom, for example. The gain variance can be solved in the same way as the IR-drop. The correction can be linear or non-linear. Even if the gain varies non-linearly, a linear approximation may be used in some embodiments. The IR-drop corrected pixel stream is output on bus 1590.

Row Noise Correction 1600 gets the pixel stream from bus 1590. It corrects for noise which may be added to all pixels of particular rows. Row Noise Correction 1600 sends pixel values to Row Averager 1700, which averages the pixel signal on special unexposed pixels, to derive the row average. Such average value is then sent back to Row Noise Correction 1600 via bus 1695, to be subtracted from each pixel of the corresponding row. The resultant Row nose corrected pixel stream is asserted on bus 1690, and output to Generic Offset Surface 1800. In other embodiments, row noise estimation may be done using a single row of special pixels. Such special pixels may be, for example, metal-covered pixels, direct pixels or regular pixels that are depleted of any photon induced charge right before the readout.

Generic Offset & Gain Surface 1800 corrects the pixels for those aberrations, which can be characterized as a continuous and slowly changing function of the X and Y coordinates of the pixel. Two separate surface functions may be employed—one for additive aberrations, and the other for multiplicative aberrations. A first type of such aberrations may result from optical phenomena which occur while the camera is capturing a scene through its lens and through its micro-lenses. An example to this first type of aberrations is lens shading. A second type of aberration of this nature is optical phenomena which occur when optical equipment is used in the manufacturing of the masks or of the semiconductor wafer. An example to this second class of aberrations is gradients in the doping level of array transistors, and a corresponding shift in their Threshold Voltage, Vₜ. An example of an additive surface function is the non-uniform heating of the sensor, resulting in varying dark content. A specific embodiment of the present invention with regards to Generic Offset Surface 1800 is detailed further below in this document.

Pixel stream from Generic Offset Surface 1800, corrected as described above, is output through bus 1890 to Digital Binning unit 1900, which performs the function of downsizing with anti-alias correction and noise reduction, in the vertical and/or the horizontal dimension. Such downsizing is accomplished by summing the values of neighboring pixels. The summing may be direct, where actual values are added, or weighted, where the various pixels are multiplied by a relative weight factor before being summed. Such weighted summing may, for example, assign higher weight to center pixels, so that the summing will have the effect of low-pass filtering. The result of the summing may be divided by the number of pixels, or by the total of the weights, or by any other fixed number.

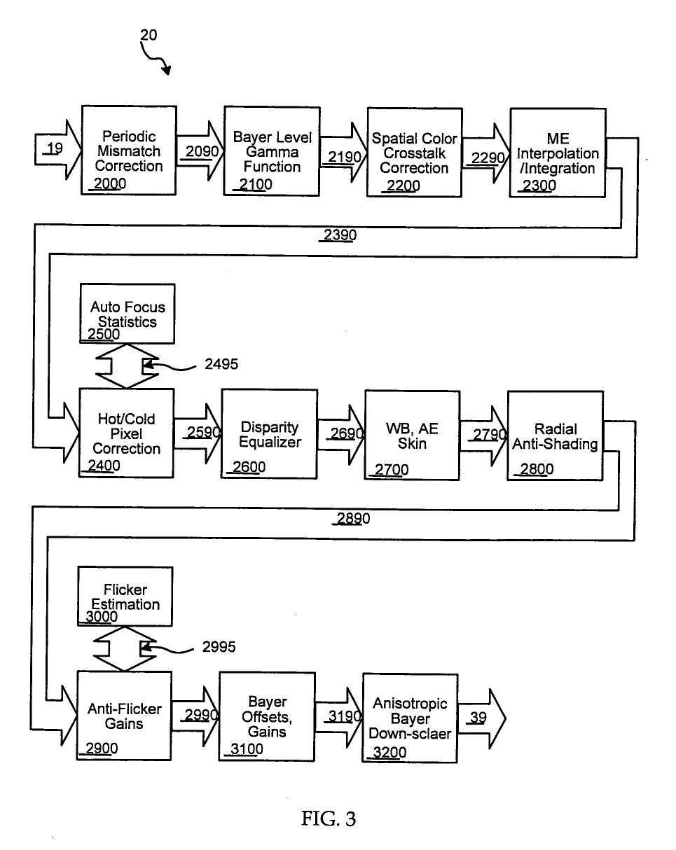

Digital Binning is the last stage of the Initial Bayer Domain Processing. Digital Binning unit 1900 outputs the binned pixel stream on its output bus 19, to Periodic Mismatch Correction 2000, which is the first stage of Further Bayer Domain Processing 20, shown in FIG. 3.

Periodic Mismatch Correction 2000 corrects the pixel stream for those aberrations which may have a periodic nature, in the horizontal and/or the vertical dimensions. Such aberrations stem from circuits, common to groups of several columns and/or several rows, with identical electrical design but with layout which is not perfectly symmetrical for all columns and/or rows. Aberrations will, in this case, assume a periodic nature, and repeat with the next instance of said circuits.

Output 2090 from Periodic Mismatch Correction 2000 enters Bayer Level Gamma Function 2100, where the values of the pixels are converted to LUT-programmable function which may be a power function of the form: Pₒᵤₜ=Pᵢₙ^{Gamma}, with Gamma being a programmable or a fixed value. The purpose of the Bayer Level Gamma Function is to increase the dynamic range of the pixels. Unit 2100 may be implemented using a piece-wise linear approximation, as is well described in the literature. The result of the calculation is output on Bus 2190.

Output 2190 from Bayer Level Gamma Function 2100 is asserted at the input of Spatial Color Crosstalk Correction unit 2200, which corrects the value of each pixel for the interaction of neighboring pixels.

Output from Spatial Color Crosstalk Correction 2200 is asserted on bus 2290, which, in turn, is connected to the input of ME (Multiple Exposure) Interpolation/Integration 2300. This block supports a special high dynamic range mode, which constitutes another embodiment of the present invention, and which is referred to below as ME.

When in ME mode, each subsequent pair of rows is exposed with alternating different time intervals. For example, suppose T1 and T2 are a long and a short exposure time interval, respectively. Rows 1 and 2 may be exposed with time interval T1, rows 3 and 4 with time interval T2, rows 5 and 6 again with T1, rows 7 and 8 with T2, and so on. T1 and T2 are dynamically adjusted so as to achieve high overall dynamic range, where some of the brighter image details, which may be saturated when exposed with T1, will register well in the rows exposed with T2. The darker parts of the image, conversely, will register better when exposed with T1.

ME interpolation/Integration block 2300 may perform the following function in one embodiment: for each input pixel value, the corresponding output pixel value equals a function of the current pixel value and the vertical interpolation of the pixels above and below the current pixel. Said function may be in some embodiments a simple average. Output image from ME Interpolation/Integration 2300, which may have higher dynamic range, is asserted on bus 2390, and output to Hot/Cold Pixel Correction 2400.

Hot/Cold Pixel Correction 2400 detects and corrects pixels which may be defective. The nature of the defect may be permanent or intermittent. In addition, the defective pixel may be too bright (“hot pixel”) or too dark (“cold pixel”). Unlike prior art techniques, unit 2400 can detect and correct clusters of defective pixels. One embodiment of algorithm works by analyzing each pixel in each frame on an ongoing basis without considering results from past frames as described below.

For each pixel, a 5×5 neighborhood of pixels surrounding the current pixel is taken in the Bayer domain. In this embodiment, the 5×5 neighborhood is reduced to a cluster of twelve surrounding pixels. Each of the pixels in the cluster are converted to grayscale. The conversion to grayscale is performed by addition in this embodiment. The relevant offsets for the addition are calculated in each point of the frame using mean neighborhood values of each color. Outliers are discarded from the cluster after grayscale conversion, for example the highest and lowest one or two pixels are removed from the cluster. The range of values for the culled cluster is determined. Some embodiments may multiply the range of values of the culled cluster by a factor, for example, 0.8, 1, 1.1, or 1.2 to optionally increase or decrease the range of values.

The current pixel is also converted to grayscale using addition and mean neighborhood values for each color. The current pixel, after grayscale conversion, is compared to the range of values. If outside the range, the current pixel is discarded as being a hot or cold pixel. A replacement pixel is determined by interpolation of neighboring pixels and replaces the current hot or cold pixel. The hot/cold corrected pixel stream is asserted on bus 2590, and output to Disparity Equalizer 2600.

Auto-Focus Statistics unit 2500 works in conjunction with Hot/Cold Pixel Correction 2400. It accumulates high spatial frequency statistics from the pixel stream, to be used as input to auto-focus algorithm.

Disparity Equalizer 2600 equalizes the disparity of the two types of green pixels (i.e., odd green pixels and even green pixels in the Bayer pattern). Its output is asserted in bus 2690, and input to WB, AE, Skin unit 2700. Due to the manufacturing process, there might be some difference between the two types of green pixels when viewing a uniform color. The green disparity is found both in calibration and adaptively.

In some cases, this difference is merely the texture of the green in the scene, but in others it is an artifact. For example, a grid in the scene may create a checkerboard pattern similar to the green disparity. But, when looking at a uniform color, there should be no checkerboard pattern. The Disparity Equalizer 2600 determines when a checkerboard pattern is a result of green disparity in an adaptive manner. Where a periodic pattern is determined in a 7×5 matrix, the adaptive algorithm works to correct the green disparity. Some embodiments determine the frequency of any periodicity in the matrix to further discern if the periodicity is likely to be from the scene or from the green disparity phenomenon.

There is some green disparity that is not determined adaptively and can be determined during calibration. This disparity only occurs in one direction of the image sensor. Different colors viewed by the image sensor can characterize the amount of cross-talk expected. With a white incident image produces a first amount of cross-talk and a blue incident image produces a second amount of cross-talk. This allows modeling the cross-talk such that the determined parameters can be used in disparity correction to fix the cross-talk based upon this calibration. Adaptive detection of green disparity is applied in addition to the determined parameters found in calibration.

WB, AE, Skin unit 2700 has three functions. First, it measures statistics for white balance, and corrects the colors accordingly. Second, it collects statistics for automatic exposure (AE) control; and, third, it comprises measures to detect color of human skin, and to correct it according to user's preferences. WB, AE, Skin block 2700 asserts its output on bus 2790.

Radial Anti-Shading unit 2800 gets the pixel stream on bus 2790. It corrects for that part of lens shading which is a function of the distance of the corrected pixel from the center of the image sensor. Its output is asserted on bus 2890.

Anti-Flicker Gains unit 2900 corrects for flicker. Unlike prior art methods, which correct flicker effects only by changing the scan frequency, and are thus limited, block 2900 corrects for flicker by estimating the attenuation for each video line as a result of the flicker, and applying calculated gain to compensate for such attenuation. Flicker Estimation unit 3000 works in conjunction with Anti-Flicker Gains 2900, collecting the flicker statistics and estimating its frequency.

The output From Anti-Flicker Gains 2900 is asserted on bus 2990, and input to Bayer Offset & Gains unit 3100. This unit provides additional programmable gain and offset for each of the four Bayer color components. Its output is asserted on bus 3190, and input to Anisotropic Bayer Downscaler 3200.

Anisotropic down-scaling may be used for those configurations in which downsizing in the vertical and the horizontal dimensions, by binning and/or by sub-sampling, are not done to the same down-sizing factors.

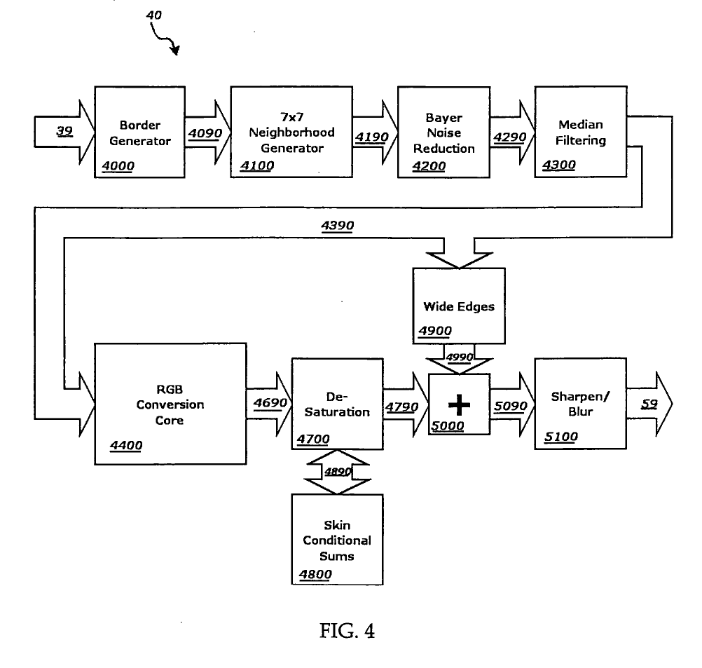

The output of Anisotropic Bayer Downscaler 3200 is asserted on bus 39, and output to Border Generator 4000 (FIG. 4), which adds a 2-pixel-wide border stripe around the image. This border is needed to avoid edge artifacts of the image processing algorithms to follow.

The output of Border generator 4000 is asserted on bus 4090, and output to Neighborhood Generator 4100, which generates the 5×5 neighborhood of the pixel being processed, but other embodiments could implement a neighborhood of a different size, for example 7×7. This 5×5 neighborhood, including the pixel being processed, is asserted on bus 4190 and output to Bayer Noise Reduction unit 4200. Any missing pixels from the neighborhood are generated by interpolation in the Border generator 400 such that a 5×5 neighborhood is possible even at the edges of the image sensor.

Many algorithms when processing the Bayer image become very complex as the processing may start with a green-blue column/row or a red-green column/row. In one embodiment, the red-green column/row is discarded at two edges of the image sensor such that one algorithm can be used for the image or mirrored image as the green-blue column/row is used initially. This discards one row and column, which is replaced by a spare row and column in the image sensor. In this way, the first pixel in every line is green instead of red in some circumstances.

Bayer Noise reduction 4200 performs an edge preserving noise reduction, where noise is mitigated without blurring the edges in the picture. This is done as follows in one embodiment. The absolute of the difference between the values of each of the eight neighbor pixels of the center pixel and the center pixels is evaluated. If it is greater than a pre-programmed threshold, an edge is assumed, and those neighbor pixels will be ignored. If the difference is less than or equal to said threshold, the variations are considered to be noise. Next, the center pixel is replaced by the average of those neighbor pixels with the smaller difference, and of the value of the center pixel. Such average may be done with equal weights to all pixels, or with different weights to the center and the neighbor pixels. Moreover, different set of neighbor pixels may be chosen, all in the scope of the present invention.

In some embodiments, a weighted average function may be used when the center pixel is evaluated, whereas the weight of each neighbor pixel is a function of its difference from the center pixel.

The output of Bayer Noise Reduction 4200 is asserted on bus 4290, and output to Median Filtering 4300, which enhances the pixel stream by replacing each pixel with the median of its environment, and sends its output on bus 4390, to RGB Conversion Core 4400, and to Wide Edges unit 4900.

Demosaicing is performed by the RGB conversion Core 4400 by using the median filtered noise-reduced 5×5 neighborhood input from bus 4390, to generate RGB data for each pixel, and outputs it on bus 4690. RGB Conversion Core 4400 will be described to detail further below. One embodiment performs gamma correction prior to the RGB conversion Core 440. After the demosaicing, an inverse gamma correction is performed after the Sharpen/Blur block 5100. In this way, demosaicing and sharpening are performed on a gamma corrected image.

De-Saturation unit 4700 gets its input from RGB Conversion Core 4400, on bus 4690. Its function is to decrease color saturation level in some cases, most noticeably when color aliasing is detected. Skin Conditional Sums unit 4800 collects statistics from the pixel stream, which is used for the detection of human skin—the skin color may be preserved and not de-saturated. Unit 4800 may work in conjunction with De-Saturation unit 4700, indicating pixels which are part of the human skin, and changing it according to certain criteria. Output from De-Saturation 4700 is asserted on bus 4790, and input to Adder block 5000.

Output from Median Filtering 4300, which is a noise-reduced and median-filtered 5×5 neighborhood, is also presented at the input of Wide Edge unit 4900, which detects wide edges, and generates a numeric data to be added to each pixel which is detected as belonging to a wide edge. Such numeric data is asserted on bus 4990, and sent to Adder 5000, which adds the pixel stream from De-Saturation 4700 to the wide edges from unit 4900, to generate pixel stream with enhanced wide edges, and assert it on bus 5090.

Output from Adder 5000 is input to Sharpen/Blur unit 5100. This unit may be used to enhance local edges, which are narrower than those enhanced by Wide Edge unit 4900. By changing a parameter, this same unit may be used to blur the image, which may be needed to avoid aliasing in subsequent image down-sampling and can optionally be done when a full resolution image is not required.

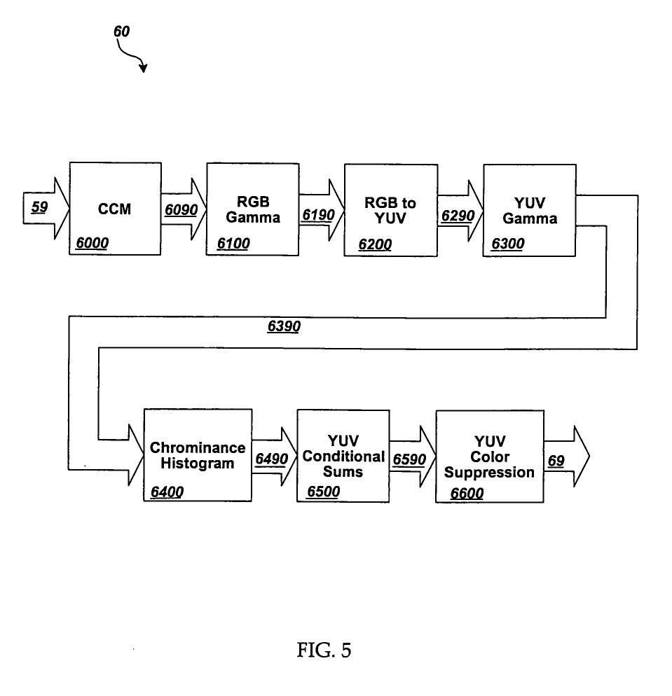

Output from Sharpen/Blur unit 5100 is a high quality RGB stream. It is asserted on bus 59, and presented at the input of unit 6000 (FIG. 5). A CCM unit 6000 is a color correction matrix, multiplying a 3×3 matrix by the RGB vector, to receive a corrected color vector. The output from unit 6000 is asserted on bus 6090, and output to RGB Gamma unit 6100.

In another embodiment, a different algorithm is used for the CCM unit 6000. There are six different 3×3 matrixes used to correct the corrected vector. A CMY color wheel is divided into six 60° slices where each has its own 3×3 matrix, for example, one slice for each of red, green, blue, yellow, cyan and magenta. There may be continuity problems between the six different slices since each has a different matrix. For example, small changes in color could switch from one matrix to another. Linear algebra is used such that there is no continuity problem for colors near the edge of two different slices. Other embodiments could divide the CMY color wheel into any number of slices.

By adjusting the 3×3 matrixes, the colors can be adjusted for each slice of the color wheel. This allows brightening a particular color and not others. Special effects can be performed by adjusting the 3×3 matrixes. For example, a particular slice of the CMY color wheel could be made accentuated, while the others are changed to grey scale.

RGB Gamma unit 6100 comprises three lookup tables, where for every value of R, G or B, a gamma-corrected value is stored. In certain embodiments of the present invention RGB Gamma unit 6100 comprises RAM based tables. In other embodiments it may comprise a RAM with entries for a subset of the possible values, and with interpolation circuit for the R, G or B values which fall between the entries in said table. In certain embodiments, the three tables may be identical; yet in other embodiments, independent values could be used for the three tables, allowing extra flexibility, for example, for white balance.

Output from RGB Gamma unit 6100 is asserted on bus 6190, and output to RGB to YUV block 6200, where a conversion is done from the RGB space to the YUV space. The YUV output is asserted on bus 6290, and output to YUV Gamma unit 6300.

YUV Gamma unit 6300, similarly to RGB Gamma unit 6100, comprises three lookup tables, each of which may comprise, in certain embodiments, a partial RAM table and linear interpolation circuit. Its output is asserted on bus 6390.

Chrominance Histogram 6400 gets its input from bus 6390. It collects statistics and builds histograms for color distribution in the image. Chrominance Histogram 6400 transfers its input unchanged to bus 6490.

YUV Conditional Sums unit 6500 sums color components which pass some threshold conditions. Its output bus 6590 is identical to its input bus 6490.

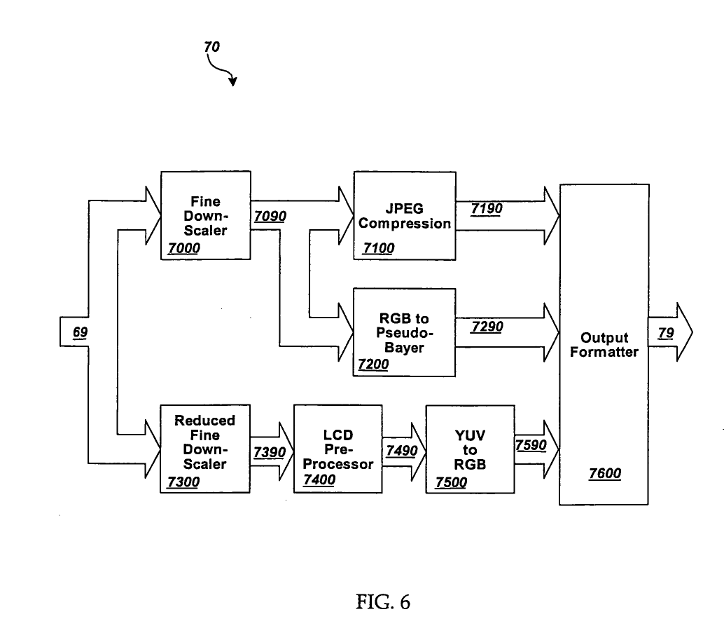

YUV Color Suppression unit 6600 attenuates the color saturation in areas where high saturation colors do not look good, for example on edges. Its output is asserted on Bus 69, and drives the input of Fine Downscaler 7000 and Reduced Fine Downscaler 7300 (FIG. 6).

Image sensor 1 may output two parallel video streams, where one stream is used, for example, for high quality JPEG compression, while the other stream may be used for preview on a small format screen, which may be, for example, an LCD screen. For that purpose, video stream on bus 69 may be split to two paths—a first path through Fine Down-Scaler 7000, JPEG Compression 7100 and RGB to Pseudo-Bayer 7200. A second path may be through Reduced Fine Downscaler 7300, LCD Preprocessor 7400 and YUV to RGB unit 7500.

Fine Resolution Downscaler 7000 accurately downscales the image by a factor which is not necessarily an integer number. In some embodiments, this factor may be any n/m where n and m are integer numbers, 2m>n>m and 1024>m>0.

JPEG Compression operation in unit 7100 may be done according to the JPEG compression standards, as widely described in the literature. Output of JPEG Compression Unit 7100 is asserted on bus 7190, and forwarded to Output Formatter 7600.

RGB Pseudo-Bayer 7200 may be used for cases where other integrated circuits or software programs, located in the same system, are capable of processing Bayer input. In this eventuality RGB to Pseudo-Bayer 7200 may generate Bayer output from the high quality RGB stream, and output it on bus 7290 to Output Formatter 7600.

In the parallel path, data from bus 69 is introduced to Reduced Fine Downscaler 7300, which may be a simplified version of Fine Downscaler 7000. While Fine Downscaler 7000 may support large format images at its output, LCD displays are usually much smaller, so that Reduced Fine Downscaler 7300 may be significantly smaller and consume significantly less power than Fine Downscaler 7000.

Output pixel stream from Reduced Fine Downscaler 7300 is asserted on bus 7390, and output to LCD Preprocessor 7400, which prepares the video data for display on an LCD screen. Such preparation may include, among others, gamma correction, edge enhancement, and color adjustment.

Output pixel stream from LCD Preprocessor 7400 is asserted on bus 7490, and output to YUV to RGB block 7500, which converts the video format, using matrix multiplication in some embodiments, and possibly using non-linear correction. The output of YUV to RGB block 7500 is forwarded through bus 7590 to Output Formatter 7600.

Output Formatter 7600 formats and multiplexes the three inputs on busses 7190, 7290, 7590, and asserts the final output of apparatus 1 on bus 79.

In a specific embodiment, Generic Offset Surface 1800 corrects the Photo Response Non-Uniformity (“PRNU”) by using approximation functions in an image sensor. In image sensors, a significant source of PRNU can be attributed to gradients of electrical parameters resulting from the wafer manufacturing process, and to gradients caused by the optical characteristics of the image sensor's lens. The PRNU caused by such gradients can be characterized as continuous functions across the face of the image sensor. Using standard x and y mapping of the sensor face, the PRNU may be characterized as continuous functions of x and y. Furthermore, the approximation functions can reduce processing requirements without the need to store and process correction tables.

In one embodiment, a two dimensional polynomial of order n, n=1, 2, 3, etc is used as the approximate function. As persons skilled in the art are aware, the higher the order of n, the greater the accuracy provided by the approximation function. In an embodiment of the present invention, a two-dimensional polynomial of order n=3 is used as the approximation function. However, other values of n may be used in alternative embodiments. In embodiments of the present invention, the PRNU of the pixels of the image sensor are measured and the parameters of the 2-dimensional polynomial of order n=3 are calculated, wherein the parameters are calculated by best fitting the 2-dimensional polynomial of order n=3 to the PRNU of the pixels. For purposes of functional approximation of the PRNU wherein the approximation function is a 2-dimensional polynomial of order n=3 , four parameters of the 2-dimensional polynomial of order n=3 may be stored in a processor associated with the image sensor in order to process the PRNU correction factors for the image sensor. In different embodiments, different numbers of parameters may be calculated and stored for PRNU correction.

In an embodiment of the present invention, image processing to correct for PRNU is performed by calculating the PRNU correction factor for each pixel in the image sensor using the 2-dimensional polynomial of order n=3 and the stored parameters which were pre-calculated by best fitting the approximation polynomial to the PRNU of the image sensor. In embodiments of the present invention, rather than calculating a correction factor for each pixel of the image sensor individually—using the approximation function, the stored parameters and the pixel location—the image sensor is scanned in a known order—i.e., the two dimensional face of the image sensor, x and y, is scanned in a known order—and correction factors are iteratively determined. In an embodiment of the present invention using iterative calculation and a 2-dimensional polynomial of order n=3 , three adders may be used in a circuit to calculate the PRNU corrections across the image sensor. In an embodiment of the present invention, registers or similar devices may be loaded with the initial values for scans across the image array. Iterative processing of correction values means that processing requirements and associated power requirements may be greatly reduced by the present invention.

Certain embodiments herein improve image accuracy and save table memory as well as power when compared to other techniques that either do not perform correction for PRNU or use tabular processes to determine correction factors. In an embodiment of the present invention, by scanning an image sensor in a known sequence and using iterative calculations across the image sensor based on an nth order two-dimensional polynomial, a method and system for calculating PRNU for an image sensor is provided where only n adders are used, provided that the horizontal blank period is at least n+1 pixels long.

In an embodiment of the present invention, correction factors are determined by scanning across the image sensor in a known order and performing iterative calculations using relative differences in position on the sensor—Δx, Δy—and the results of previous calculations, rather than using the approximation function to calculate the value for each value of x and y on the image sensor. In this way, in an embodiment of the present invention where the approximation function is a 2-dimensional polynomial of order n=3, only three adders need be used to calculate PRNU correction factors using iterative calculations. While the use of three adders is discussed, the invention described is general, and can be readily extended to any polynomial order n, using only n adders, provided that the horizontal blank period is at least n+1 pixels long.

In one embodiment, the present disclosure provides a two-dimensional correction function F(x,y), where x and y define the location of a pixel relative to the center of the sensor array (0,0). The function can generate a multiplicative or an additive correction factor, or a combination of a multiplicative or additive correction factor for each pixel:

(1) P′(x,y)=P(x,y)*F₁(x,y)+F₂(x,y)

In an embodiment of the present invention, an approximate of a correction function using n-order two-dimensional polynomials may be described:

$$F ( x , y ) ≅ {\sum }_{k = 0}^{n} {\sum }_{i = 0}^{k} {C}_{ik} {x}^{i} {y}^{k - i} = F ( 0 , 0 ) + {\sum }_{k = 1}^{n} {\sum }_{i = 0}^{k} {C}_{ik} {x}^{i} {y}^{k - i} \qquad ( 2 )$$

In this embodiment, x and y are the offsets of a particular pixel from the center of the sensor array, and n is the order of the polynomial.

In an embodiment of the current invention, the order of the polynomial is 3, i.e., n=3 . In other embodiments, higher or lower order 2-dimensional polynomials may are used.

In an embodiment where n=3 , equation (2) becomes:

(3) F(x,y)=F(0,0)+C₀₁y+C₁₁x+C₀₂y²+C₁₂xy+C₂₂x² +C₀₃y³+C₁₃xy²+C₂₃x²y+C₃₃x³

In an embodiment of the present invention, the array is scanned and the increments for x and y are denoted as Δx, Δy. As persons skilled in the art are aware, image sensors may support reverse scanning in either or both dimensions, as well as 1:2 or higher order sub-sampling. As such, a typical sensor might have four possible values for the increments Δx, Δy:

(4) Δx, Δy ε{+2,+1,−1,−2}

In alternative embodiments of the present invention, however, the values of Δx, Δy can be any integer number.

X Axis Calculation Circuit

An analysis may be performed as to how F changes as a line y is scanned. In an embodiment of the present invention, the results of this analysis may be implemented. In such an embodiment, the line y starts with x=X0. In this embodiment, the initial value of F at the start of the scan of the line y is F(X0,y).

In an embodiment of the present invention, the difference equations along the X axis are as follows:

$$\begin{matrix}{DX}^{1} ( X , y ) = F ( x + Δ x , y ) - F ( x , y ) = Δ {x}^{*} ( {C}_{11} + {C}_{12} * y + 2 * {C}_{22} * x + {C}_{13} * {y}^{2} + 2 * {C}_{23} * x * y + 3 * {C}_{33} * {x}^{2} ) + Δ {x}^{2} * ( {C}_{22} + {C}_{23} * y + 3 * {C}_{33} * x ) + Δ {x}^{3} * {C}_{33} & ( 5 ) \\ {DX}^{2} ( x , y ) = {DX}^{1} ( x + Δ x , y ) - {DX}^{1} ( x , y ) = Δ {x}^{2} * ( 2 * {C}_{22} + 2 * {C}_{23} * y + 6 * {C}_{33} * x ) + Δ {x}^{3} * 6 * {C}_{33} & ( 6 ) \\ {DX}^{3} ( x , y ) = {DX}^{2} ( x + Δ x , y ) - {DX}^{2} ( x , y ) = Δ {x}^{3} * 6 * {C}_{33} & ( 7 )\end{matrix}$$

The initial value of F(X0,y) for each new line y is:

(8) F(X0,y)=F(0,0)+C₀₁y+C₁₁X0+C₀₂y² +C₁₂X0y+C₂₂X0² +C₀₃y³+C₁₃X0y²+C₂₃X0²y+C₃₃X0³

And the initial value of the differences for each new line y is:

(9) DX¹(X0,y)=Δx*(C₁₁+C₁₂*y+2*C₂₂*X0+C₁₃*y²+2*C₂₃*X0*y+3*C₃₃*X0²)+Δx²*(C₂₂ +C₂₃*y+3*C₃₃*X0)+Δx³ *C₃₃

(10) DX²(X0,y)=Δx²*(2*C₂₂+2*C₂₃*y+6*C₃₃*X0)+Δx³*6*C₃₃

(11) DX³(X0,y)=Δx³*6*C₃₃

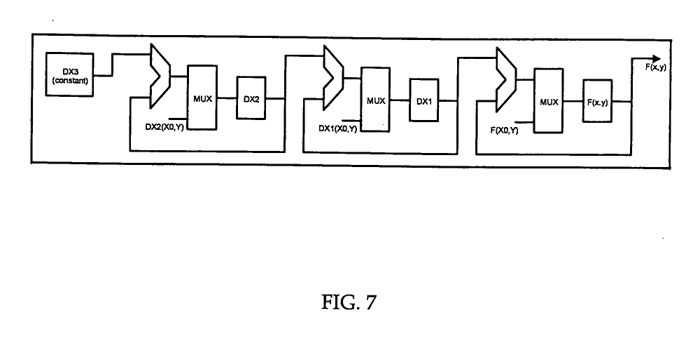

FIG. 7 illustrates the x-part of an implementation of the present invention. In this implementation, the two muxes are used to load the initial values DX²(X0,y), DX¹(X0,y) into the registers just before the line scan starts. In an embodiment of this implementation, the muxes route their upper input to the output, and the circuit works like a 3-stage integrator.

Furthermore, in the implementation of the present invention disclosed in FIG. 1, the initial values, which are loaded into the registers whenever a new line begins, change from line to line.

Y Axis Calculation Circuit

In an embodiment of the present invention, y-wise integrators are used to calculate the initial values F(X0,y), DX¹(X0,y) and DX²(X0,y). In such an embodiment, the initial value of F(X0,y), is derived from equation (3):

(12) F(X0,y)=F(0,0)+C₀₁y+C₁₁X0+C₀₂y²+C₁₂X0y+C₂₂X0²+C₀₃y³+C₁₃X0y²+C₂₃X0²y+C₃₃X0³

The Y axis difference equation of (12) are:

$$\begin{matrix}{DY}^{1} ( F ) = ( C 01 Δ y + {C}_{02} Δ {y}^{2} + {C}_{12} X 0 Δ y + {C}_{03} Δ {y}^{3} + {C}_{13} X 0 Δ {y}^{2} + {C}_{23} X {0}^{2} Δ y ) + y * ( 2 {C}_{02} Δ y + 3 {C}_{03} Δ {y}^{2} + 2 {C}_{13} X 0 Δ y ) + 3 {y}^{2} {C}_{03} Δ y & ( 13 ) \\ {DY}^{2} ( F ) = ( 2 {C}_{02} Δ {y}^{2} + 6 {C}_{03} Δ {y}^{3} + 2 {C}_{13} X 0 Δ {y}^{2} ) + 6 {C}_{03} y Δ {y}^{2} & ( 14 ) \\ {DY}^{3} ( F ) = 6 {C}_{03} Δ {y}^{3} & ( 15 )\end{matrix}$$

The Y axis difference equations of the initial value of DX¹(X0,y), may be derived from equation (9):

(16) DY¹(DX1(X0,y))=y*(2*Δx*Δy*C₁₃)+(Δx*Δy²*C₁₃+2*X0*Δx*Δy*C₂₃ +Δx²*Δy C₂₃+Δx*Δy*C₁₂)

(17) DY²(DX1(X0,y))=2*Δx*Δy²*C₁₃

The Y axis difference equations of the initial value of DX²(X0,y) may be derive from equation (10):

(18) DY¹(DX²(x,y))=2*Δx²*Δy*C₂₃

In an embodiment of the present invention, the Y dimension difference equations (equations 12-18) are loaded with initial values when the scan of line Y restarts, i.e., on each new frame. In such an embodiment, the first line of each frame is denoted as Y0. The initial values will be:

$$\begin{matrix}F ( X 0 , Y 0 ) = F ( 0 , 0 ) + {C}_{01} Y 0 + {C}_{11} X 0 + {C}_{02} Y {0}^{2} + {C}_{12} X 0 Y 0 + {C}_{22} X {0}^{2} + {C}_{03} Y {0}^{3} + {C}_{13} X 0 Y {0}^{2} + {C}_{23} X {0}^{2} Y 0 + {C}_{33} X {0}^{3} & ( 19 ) \\ {DY}^{1} ( F ( X 0 , Y 0 ) ) = ( C 01 Δ y + {C}_{02} Δ {y}^{2} + {C}_{12} X 0 Δ y + {C}_{03} Δ {y}^{3} + {C}_{13} X 0 Δ {y}^{2} + {C}_{23} X {0}^{2} Δ y + 3 Y {0}^{2} {C}_{03} Δ y ) + Y 0 * ( 2 {C}_{02} Δ y + 3 {C}_{03} Δ {y}^{2} + 2 {C}_{13} X 0 Δ y ) & ( 20 ) \\ {DY}^{2} ( F ( X 0 , Y 0 ) ) = 2 {C}_{02} Δ {y}^{2} + 6 {C}_{03} Δ {y}^{3} + 2 {C}_{13} X 0 Δ {y}^{2} + 6 {C}_{03} Y 0 Δ {y}^{2} & ( 21 ) \\ {DX}^{1} ( X 0 , Y 0 ) = Δ x * ( {C}_{11} + {C}_{12} Y 0 + 2 * {C}_{22} * X 0 + {C}_{13} * Y {0}^{2} + 2 * {C}_{23} * X 0 * Y 0 + 3 * {C}_{33} * X {0}^{2} ) + Δ {x}^{2} * ( {C}_{22} + {C}_{23} * Y 0 + 3 * {C}_{33} * X 0 ) ++ Δ {x}^{3} * {C}_{33} & ( 22 ) \\ {DY}^{1} ( DX 1 ( X 0 , Y 0 ) ) = Y 0 * ( 2 * Δ x * Δ y * {C}_{13} ) + ( Δ x * Δ {y}^{2} * {C}_{13} + 2 * X 0 * Δ x * Δ y * {C}_{23} + Δ {x}^{2} * Δ {yC}_{23} + Δ x * Δ y * {C}_{12} ) & ( 23 ) \\ {DX}^{2} ( X 0 , Y 0 ) = Δ {x}^{2} * ( 2 * {C}_{22} + 2 * {C}_{23} * Y 0 + 6 * {C}_{33} * X 0 ) & ( 24 )\end{matrix}$$

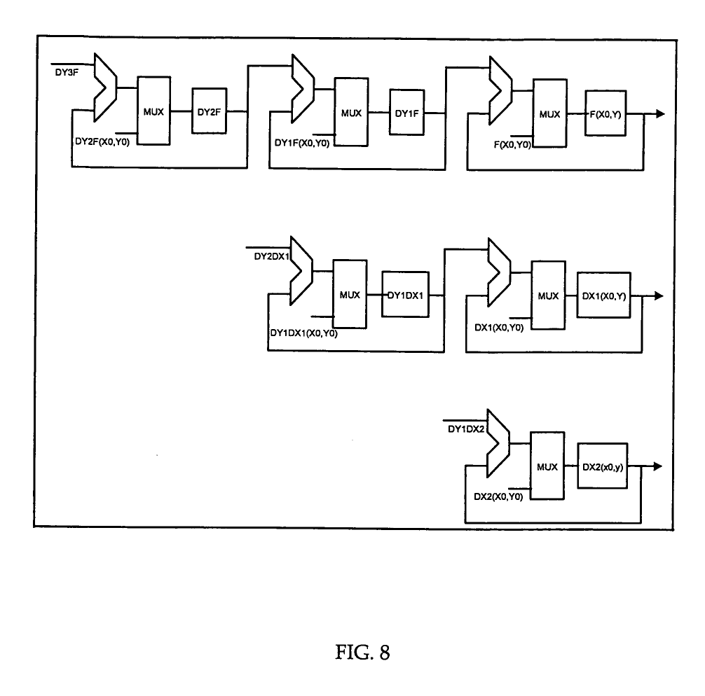

FIG. 8 illustrates the Y-part an implementation of the present invention.

The two figures, FIG. 7 and FIG. 8, together illustrate a full, non-optimized, data path implementation of one embodiment of the present invention. In this embodiment, ten constants, nine in the Y-axis and one in the X axis, may be determined per configuration. In an embodiment of the present invention, the constants are calculated by a control processor. In an embodiment of the present invention, the control processor is a microcontroller. In an embodiment of the present invention, a control circuit is used to generate control signals for the multiplexers and load commands for the registers.

In an embodiment of the present invention, there are nine adders, the three adders shown in FIG. 7 perform an addition upon column change and the six adders shown in FIG. 8 add when the row changes. In an embodiment where the target system uses one clock per pixel, three adders are needed to implement FIG. 7. In such an embodiment, the same three adders can be used for those additions which are done upon line change. In an embodiment, where the horizontal blank period is at least four clock-cycles long, the adders of FIG. 7 can be used at that time to do the 6 line-change additions depicted in FIG. 8.

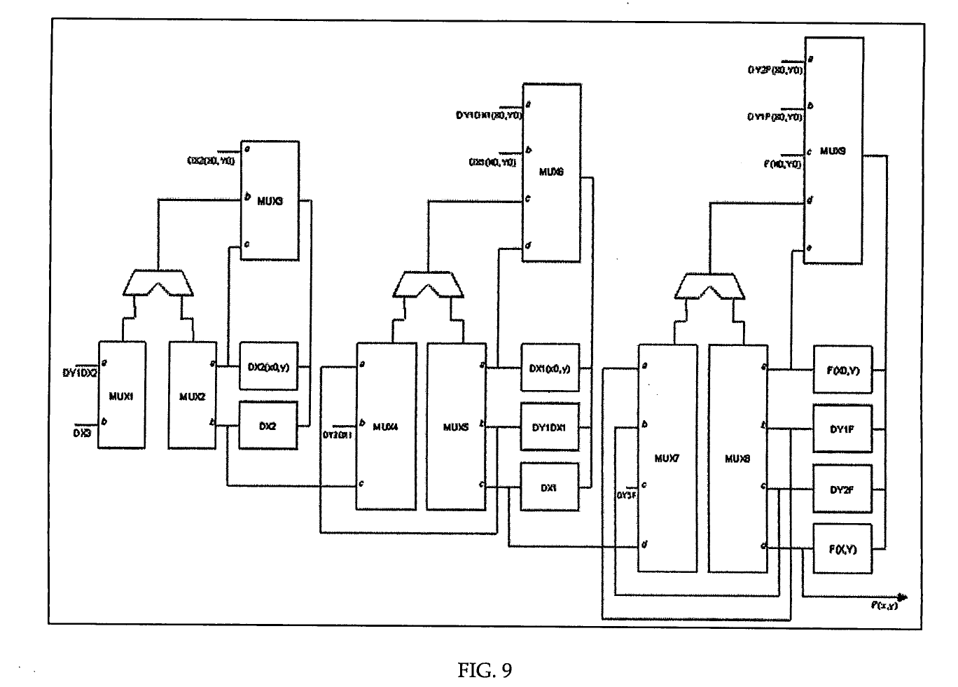

FIG. 9 depicts an embodiment in which each adder gets a pair of multiplexers on each of its inputs. In this embodiment, adder sharing is accomplished by appropriately controlling the multiplexers. The control circuit for this embodiment may be designed to perform the following, where it is assumed that an Hblank signal precedes all lines, including the first line of the frame:

Preparation of Start-of-Frame values (Vertical Registers):

Last Vblank clock:
DX2(X0,y)=DX2(X0,Y0)
DX1(X0,y)=DX1(X0,Y0)
F(X0,Y)=F(X0,Y0)
   One-Before-Last Vblank clock:
DY1DX1=DY1DX1(X0,Y0)
DY1F=DY1F(X0,Y0)
   Two-Before-Last Vblank clock:
DY2F=DY2F(X0,Y0)

### Loading Start-of-Line Values to Horizontal Registers:

Four-Before-Last Hblank clock:
DX2=DX2(X0,Y)
DX1=DX1(X0,Y)
F=F(X0,Y)

### Calculating Initial Values for New Line:

Three-Before-Last Hblank clock:
DX2(X0,Y)=DX2(X0,Y)+DY1DX2
DX1(X0,Y)=DX1(X0,Y)+DY1DX1
F(X0,Y)=F(X0,Y)+DY1F
   Two-Before-Last Hblank clock:
DY1DX1=DY1DX1+DY2DX1
DY1F=DY1F+DY2F
   One-Before-Last Hblank clock:
DY2F=DY2F+DY3F

### Pixel to Pixel Update:

For each pixel do an horizontal integration step:
F(X,Y)=F(X,Y)+DX1
DX1=DX1+DX2
DX2=DX2+DX3
   In this embodiment, the reverse order of the evaluation is used to avoid result ripple through from stage to stage.

The above embodiment of the present invention is summarized in the table below:

| | Last VB Clock | | | Last HB Clock | | | | Pixel |
|---|---|---|---|---|---|---|---|---|
| | −0 | −1 | −2 | −1 | −2 | −3 | −4 | Clock |
| Mux 1, 2 | | | | | | a | | b |
| Mux 3 | a | | | | | b | c | b |
| Mux 4, 5 | | | | | b | a | | c |
| Mux 6 | b | a | | | c | c | d | c |
| Mux 7, 8 | | | | c | b | a | | d |
| Mux 9 | c | b | a | d | d | d | e | d |
| DX2(x0, y) | load | | | | | load | | |
| DX2 | | | | | | | load | load |
| DX1(x0, y) | load | | | | | load | | |
| DY1DX1 | | load | | | load | | | |
| DX1 | | | | | | | load | load |
| F(x0, y) | load | | | | | load | | |
| DY1F | | load | | | load | | | |
| DY2F | | | load | load | | | | |
| F(X, Y) | | | | | | | load | load |

In a synchronous design, the load pulse of the registers will occur one clock cycle after the multiplexors control is set. This is omitted from the table above for simplicity, but is factored into relevant embodiments of the present invention.

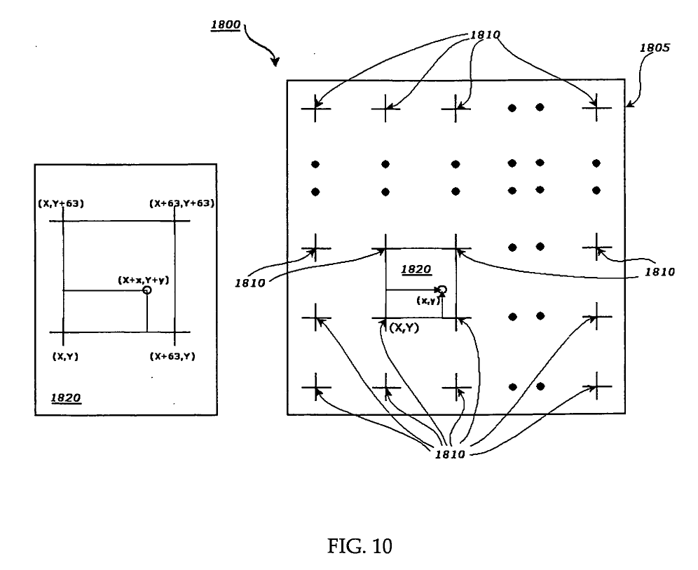

The principle of operation of another embodiment of Generic Offset Surface 1800 is depicted in FIG. 10. A grid 1810 is defined in pixel array 1805. In embodiments of the present invention, the horizontal distance between grid points and the vertical distance between grid points may be any integer numbers, including equal and unequal numbers for the X and Y dimensions, and including programmable numbers.

In one particular embodiment, the horizontal distance between grid points and the vertical distance between grid points is 64. Thus, for said particular embodiments, 768 grid points are used to cover a 2048×1576 UXGA image format.

A RAM (not shown) stores the values of the surface function F for all grid points, and when the scanned pixel is located on a grid point (X,Y), the value of the surface function will be directly read from the RAM. Both X and Y above are assumed to be multiples of 64.

Square 1820, which is enlarged and duplicated at the left portion of FIG. 10, for clarity, defines a 64×64 region of pixels, with horizontal coordinates from X to X+63, and vertical coordinates from Y to Y+63. The coordinates of pixels within square 1820 are designated (X+x,Y+y). For pixels which are not located in grid points, 0<x<64and 0<:y<64.

The value of function F for pixels which are not part of the grid, may be approximated using interpolation, according to the bi-linear interpolation equation:

F(X+x,Y+y)≈F(X,Y)*(64−x)*(64−y)+F(X+63,Y)*x*(64−y)+F(X,Y+63)*(64−y)*x +F(X+63,Y+63)*x*y

The circuit to calculate said bilinear interpolation may comprise multipliers and adders, for direct implementation of said bi-linear interpolation equation.

Alternatively, in some embodiments, the calculation could be done incrementally, along with the ordered scan of the pixels done at the sensor array. For example, if pixels are scanned line by line, and in each line pixels are scanned column by column, the difference between the values of F for consecutive pixels would be:

F(X+x+1,Y+y)−F(X+x,Y+y) F(X,Y)*(64−x−1)*(64−y)+F(X+63,Y)*(x+1)*(64−y)+F(X,Y+63)*(64−y)*(x+1)+F(X+63,Y+63)*(x+l )*y−(F(X,Y)*(64−x)*(64−y)+F(X+63,Y)*x*(64−y)+F(X,Y+63)*(64−y)*x+F(X+63,Y+63)*x*y)==−F(X,Y)*(64−y)+F(X+63,Y)*(64−y)+F(X,Y+63)*(64−y)+F(X+63,Y+63)*y.

This value is constant within a particular Rectangular 1820 and for a given scanned line Y+y, and hence F can be interpolated while in the same line and the same rectangle, using a single adder.

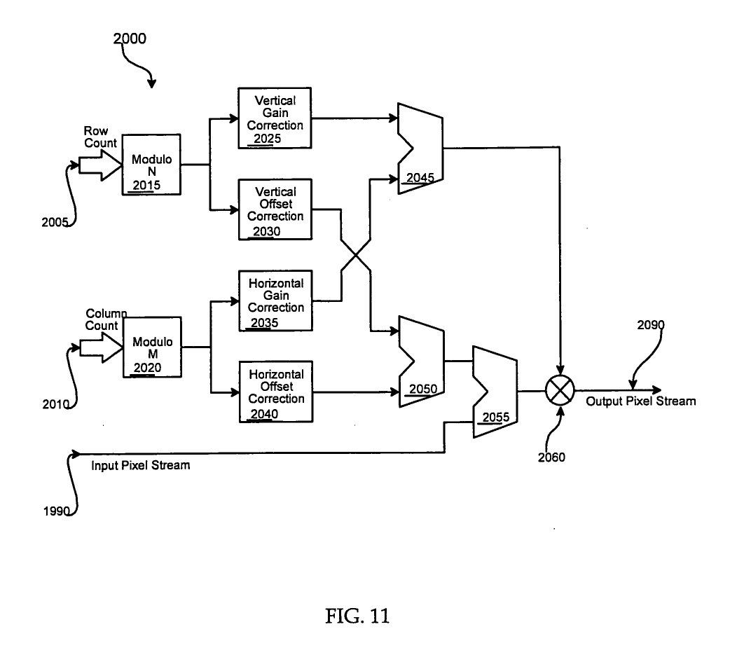

Some embodiments of Periodic Mismatch Correction 2000 are detailed in FIG. 11. Periodic gain and offset values for vertical periodic mismatch are stored in tables 2025, 2030, respectively. Similarly, periodic gain and offset values for horizontal periodic mismatch are stored in tables 2035, 2040, respectively. Tables 2025, 2030, 2035 and 2045 may, in some embodiments comprise Read Only Memory (ROM) units. In some other embodiments Tables 2025, 2030, 2035 and 2045 may comprise Random Access Memory (RAM) units.

The address input for tables 2025, 2030 is a binary number in the range of 0 to N−1, where N is the period length of the vertical period gains and offsets. Similarly, the address input for tables 2035, 2040 is a binary number in the range of 0 to M−1, where M is the period length of the horizontal period gains and offsets. Address input for tables 2025, 2030 is generated by Modulo-N unit 2015, which calculates the modulo-N result of the row count, input on bus 2005. In embodiments where N is a power of 2, Modulo-N unit 2015 may be degenerated to a fixed selection of the least significant log₂N bits of a row counter (not shown), which may be shared by other circuit of Image Sensor 1.

Similarly, address input for tables 2035, 2040 is generated by Modulo-M unit 2020, which calculates the modulo-M result of the column count, input in bus 2010, and, in embodiments where N is a power of 2, may be degenerated to a fixed selection of bits of a column counter which is not shown and which may be shared by other circuit of Image Sensor 1.

The vertical periodic gain correction output from Table 2025 and the horizontal periodic gain correction output from Table 2035, drive the inputs of Adder 2045, where a combined periodic gain is calculated by summing the two inputs.

Similarly, vertical periodic offset correction output from Table 2030, and horizontal periodic offset correction output from Table 2040, drive the inputs of Adder 2050, where a combined periodic offset is calculated by summing the two inputs.

Pixel stream 1990 first enters Adder 2055, where it is added with the combined periodic offset value output from Adder 2050, to produce a periodic-offset corrected pixel stream, which is next asserted at the input of Multiplier 2060.

Multiplier 2060 next multiplies the periodic gain correction value from Adder 2045 by the periodic-offset-corrected pixel stream from Adder 2055, to generate periodic offset and gain corrected pixel stream 2090.

In certain embodiments of the current invention, the multiplication by the periodic gain may precede the addition of the periodic offset, and thus Multiplier 2060 will connect to input pixel stream 1990 and the output of adder 2045, rather than to the output of Adder 2055 and the output of Adder 2045; and Adder 2055 will connect to the output of Multiplier 2060 and the output of Adder 2050, rather than to Input Pixel Stream 2990 and the output of Adder 2055; and, further, in said certain embodiments the periodic gain and offset corrected pixel stream is asserted at the output of Adder 2055 rather than the output of Multiplier 2060.

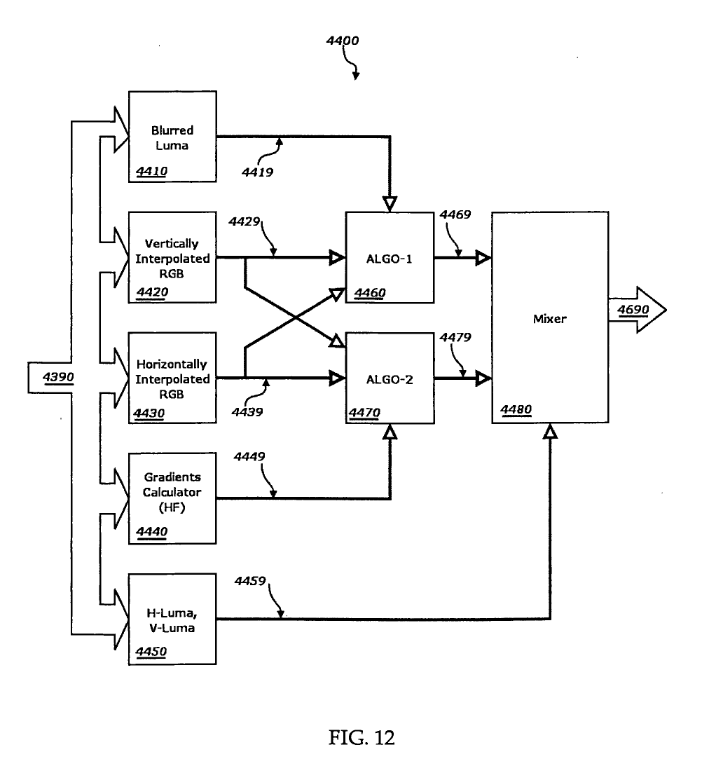

One particular embodiment of RGB conversion core 4400 (FIG. 4) is depicted in FIG. 12, and described herein. According to the present invention, certain color component R, G or B of a Bayer pixel which is not covered by a filter of the said color component, can be calculated by i) interpolating horizontal neighbors of said pixel having said color filters of said certain color component, or ii) interpolating vertical neighbors of said pixel having said color filters of said certain color component. According to embodiments of the present invention, horizontal or vertical interpolations, or, in some embodiments, combination thereof is selected according to edges in the neighborhood of said pixel.

According to embodiments of the present invention, RGB conversion may be done in parallel according to two methods, each producing an output which is optimized for a certain type of scenario, and then results may be mixed, for example, using weighted average and a mechanism which assures that for each pixel, the algorithm which fits better will prevail. In some embodiments of the present invention one such algorithm may be LPF based, providing better results for surfaces and smooth edges, while the other algorithm may be HPF based, providing better results for text and small sharp details.

In an embodiment depicted in FIG. 12, output from Median Filtering 4300 (FIG. 4), which is the noise-reduced, median-filtered 7×7 neighborhood, is input via bus 4390 to five sub units: Blurred Luma 4410, Vertically Interpolated RGB 4420, Horizontally Interpolated RGB 4430, Gradient Calculator 4440 and H-Luma, V-Luma 4450.

Vertically-interpolated RGB unit 4420, and Horizontally-interpolated RGB unit 4430, perform vertical and horizontal interpolation of the Bayer pixels, respectively, to get vertically-interpolated RGB and horizontally-interpolated RGB, which are asserted on buses 4429, 4439, respectively. Said vertically and horizontally interpolated RGB buses are each input to ALGO-1 unit 4460 and to ALGO-2 unit 4470.

Gradient Calculator 4440 calculates a high-frequency version the horizontal and vertical gradients DH and DV. This value is needed by ALGO-2 unit 4470, and it is asserted on bus 4449, which is input to the 4470 unit. Gradient Calculator 4440 first generates a vertical luminance value LV by averaging a vertically interpolated Red value, a vertically interpolated Blue value and two vertically interpolated Green values, and then taking the absolute value of the difference (LV-C), where C is the center pixel, to generate DV—the vertical grade. Similarly, Gradient Calculator 4440 generates an horizontal luminance value LH by averaging a horizontally interpolated Red value, a horizontally interpolated Blue value and two horizontally interpolated Green values, and then taking the absolute value of the difference (LH-C), to generate DH—the horizontal grade.

ALGO-2 unit 4470 receives vertically interpolated RGB pixels 4429 from unit 4420, and horizontally interpolated RGB pixels 4439 from unit 4430. It also receives the values of DV and DH from Gradient Calculator 4440, and calculates a weighted average of the vertically and horizontally interpolated RGB, with DH and DV used as weights for the average.

According to some embodiments of the present invention, ALGO-1 unit 4460 may be LPF based, and use a LPF of the Luminance environment for the calculation. Blurred-Luma 4410 may generate such low-pass luminance environment, and feed it to ALGO- 1 unit 4460, via bus 4419.

Similarly to ALGO-2, ALGO-1 unit 4460 may also calculate a weighted average of vertically interpolated RGB pixels 4429 from unit 4420, and horizontally interpolated RGB pixels 4439 from unit 4430. The weights used for such average may be a low-pass version of the grades, generated from Blurred Luma input 4419, and may be done using the same formulae used for the calculation of the HF Gradients done by 4440, with the Blurred-Luma 4419 as input rather than HF Luma.

ALGO-1 unit 4460 outputs the RGB pixels generated according to a first algorithm on bus 4469, while ALGO-2 unit 4470 outputs the RGB pixels generated according to a second algorithm on bus 4479. Both buses 4469, 4479 are input to Mixer unit 4480.

H-Luma, V-Luma unit 4450 generates vertically and horizontally interpolated luminance pixels, from the Bayer stream input via bus 4390. The two types of luminance information—vertically interpolated luminance and horizontally interpolated luminance—are presented at the input of Mixer unit 4480, which also gets RGB pixels calculated according to first and second algorithms on buses 4469, 4479, respectively. Mixer unit 4480 then calculates a weighted average of the two RGB streams, and outputs a combined RGB stream on bus 4690.

The weights for this averaging in the Mixer unit 4480 are determined, in some embodiments, by observing which of the variants is closer to gray and less colorful. In other embodiments, the weights are determined by observing for which variant of a certain pixel moves in the direction similar to that of the surrounding pixels such that an edge is likely. For example, one determination could be ALGO- 1 4460 and the other is ALGO-2 4470. Some embodiments use both ALGO-1 4460 and ALGO-2 4470 in controlling the mixer to de-emphasize one or the other.

The horizontal and vertical edges in the image may be corrected better by one of the vertically interpolated RGB unit 4420 or the horizontally interpolated RGB unit 4430. With the wrong interpolation unit 4420, 4430, the image may appear as a checkerboard pattern, for example. That checkerboard pattern can be detected in ALGO-1 4460 and the mixer can de-emphasize the interpolation unit producing the checkerboard pattern. For example, a continuity consideration is one criteria could be performed to determine which has the greatest variance and is likely a checkerboard pattern. By looking at a 3×3 matrix, the interpolation unit 4420, 4430 producing the most variation in the matrix is avoided.

Another example to find the checkerboard pattern or an edge is a chromaticity consideration because the checkerboard pattern is often colorful whereas the better algorithm is less colorful. This could be performed as ALGO-2 4470. Preferencing the less colorful 3×3 matrix produces the better image from the Mixer unit 4480. Some embodiments could use both the continuity consideration and the chromaticity consideration when choosing the better 3×3 matrix to use. The continuity consideration is weighted more heavily than the chromaticity consideration in one embodiment. False colors can be suppressed on edges appearing in the image to look the image look more natural.

For simplicity of the elaborations, pixels covered by a Red, Green, and Blue color filters, will be referred to as Red, Green and Blue pixels, respectively. Also, for the sake of simplicity, neighbor pixels of a certain center pixel will be referred to as U, R, D and L for the immediate neighbor pixel above, to the right, below and to the left of said central pixel, respectively. Also, diagonally-neighbor pixels of a certain center pixel will be referred to as UR, DR, DL and UL for the diagonally immediate neighbor pixel above and to the right, below and to the right, below and to the left and above and to the left of said central pixel, respectively. Lastly, the pixels at a distance of two from said central pixel, horizontally and vertically, will be referred to as UU, RR, DD and LL, for the pixels at a distance of two above, to the right, below and to the left of said central pixel, respectively, and said central pixel will be referred to as C.

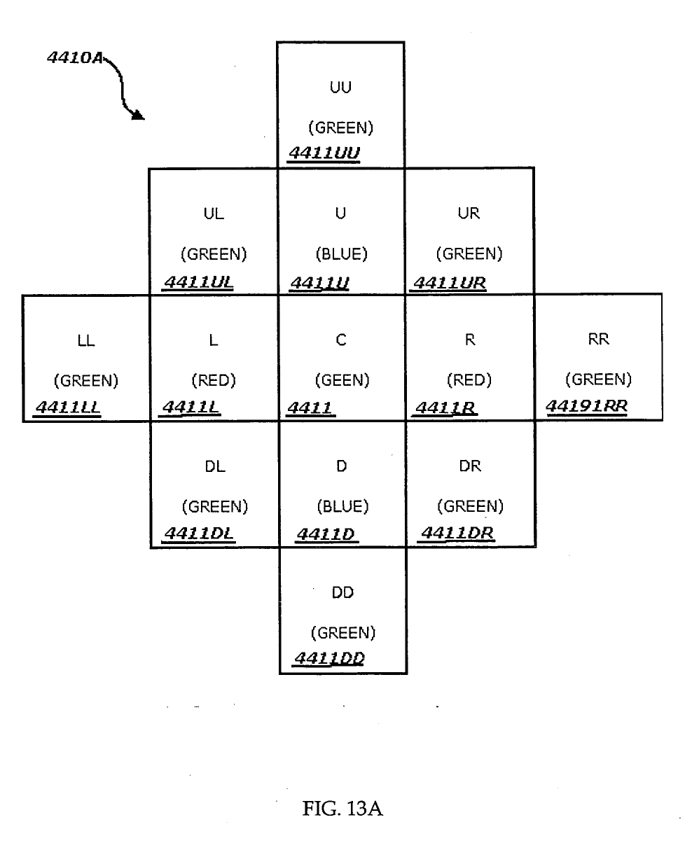

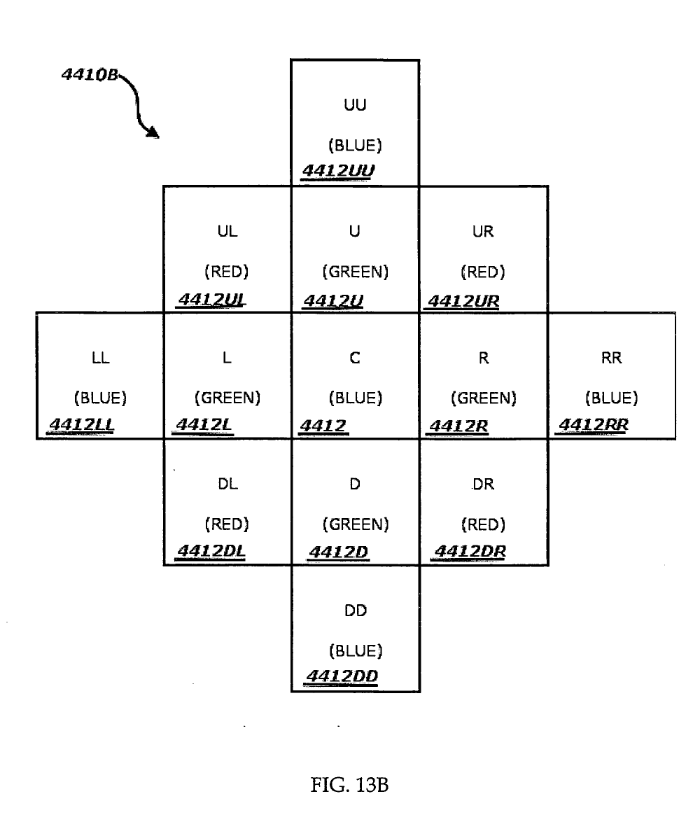

FIG. 13A depicts a neighborhood map 4410A of Green pixel 4411 in a Red line. Neighboring pixels 4411UU, 4411UL, 4411U, 4411UR, 4411LL, 4411L, 4411R, 4411RR, 4411DL, 4411D, 4411DR, 4411DD are the UU, UL, U, UR, LL, L, R, RR, DL, D, DR, DD neighbors of Center pixel 4412 (denoted C), respectively. The following values are defined and calculated: GMR_V—Green Minus Red, vertically evaluated: GMR_V=(UL+UR+DL+DR-L-L-R-R)/4; Enhance value: ENH=(2*C-UU-DD)/4OR8, when 4OR8 is a programmable constant, which may get the value of 4 or 8.

Next, the vertically evaluated value of R for this particular case, designated RV, may be calculated according to the formula: RV=C - GMR_V. Similarly, the vertically interpolated value of B for this particular case, designated BV, may be calculated according to the formula BV=(U+D)/2+ENH. Lastly, for this particular case, the vertically interpolated value of the Green component is equal to the value of the central pixel: GV=C.

FIG. 13B depicts a neighborhood map 4410B of Blue pixel 4412. Neighboring pixels 4412UU, 4412UL, 4412U, 4412UR, 4412LL, 4412L, 4412R, 4412RR, 4412DL, 4412D, 4412DR, 4412DD are the UU, UL, U, UR, LL, L, R, RR, DL, D, DR, DD neighbors of C pixel 4412, respectively. For this case the value of GMR_V=(2*L+2*R-UL-UR-DL-DR)/4, and of ENH=(2*C-UU-DD)/4OR8may be calculated, where again, 4OR8 is a programmable constant, which may get the value of 4 or 8. This time we get for RV, GV and BV:RV=(U+D)/2- GMR_V+ENH; GV=(U+D)/2+ENH; and BV=C.

The evaluation of the vertical interpolations for a central Red pixel is identical to that described above for a central Blue pixel, where Red and Blue interchange in the equations.

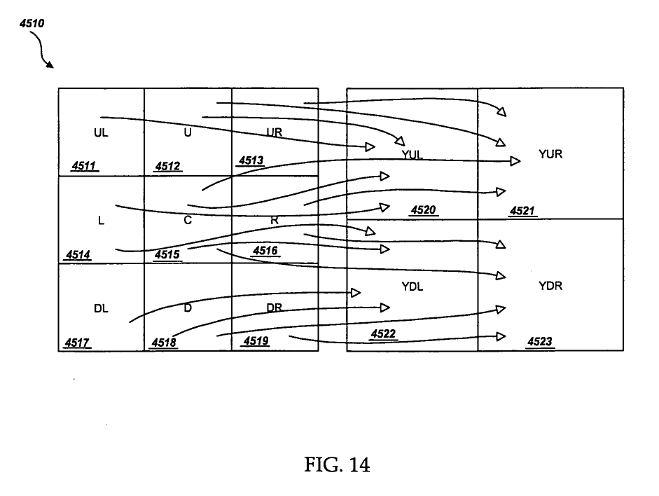

FIG. 14 depicts a graphical illustration 4510 of the operation of Blurred Luma unit 4410 (FIG. 12). As is well known, in Bayer color filter array the sum of all pixels in any 2×2 pixel square roughly represents the luminance at that neighborhood. For any central pixel 4515, four values of the luminance Y are generated: YUL 4520, YUR 4521, YDL 4522, and YDR 4523. YUL is generated by summing the upper-left four pixels: UL 4551, U 4512, L 4514 and C 4515. YUR 4521, YDL 4522 and YDR 4523 are generated in a similar manner, according to the formulae: YUL=UL+U+L+C; YUR=U+UR+C+R; YDL=L+C +DL+D; and YDR=C+R+D+DR.

Further, Luminance Y value for center pixel 4515 may be determined by calculating the median of the four values:

$$Y ( C ) = median ( YUL , YUR , TDL , YDR ) == ( YUL + YUR + YDL + YDR - MAX ( YUL , YUR , YDL , YDR ) - MIN ( YUL , YUR , YDL , YDR ) ) / 2$$

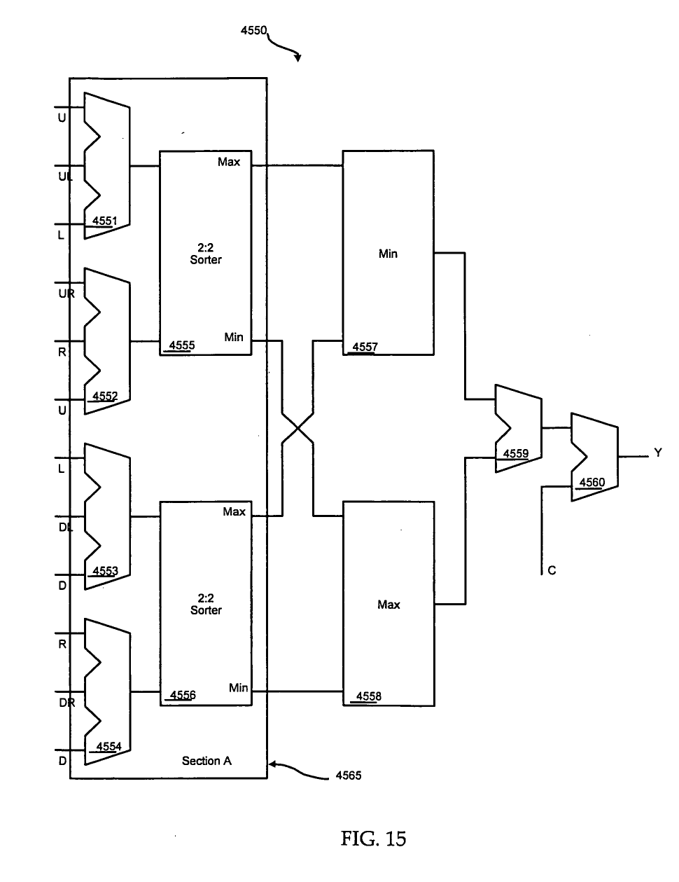

FIG. 15 depicts an embodiment of Blurred Luminance Calculation done in unit 4410 (FIG. 12) in accordance to the equation above. Three input adders 4551, 4552, 4553, 4554, each of which may be implemented using two two-input adders, sum the values of neighbor pixels U, UL, L; UR, R, U; L, DL, D; and R, DR, D, respectively, and forward the sums to 2:2 Sorters 4555 for the first three input adders 4551 and 4552; and 4556 for the three input adders 4553 and 4554.

Each of 2:2 Sorters 4555 and 4556 sort two inputs, and assert the value of the larger one on the output port designated “Max”, and the smaller one on the output designated “Min”. If the two inputs are identical, then the two outputs will be identical, and equal to the two inputs. 2:2 Sorters 4555 and 4556 may be implemented using one comparator and two 2:1 multiplexers.

Further, Min unit 4557 outputs the smaller of its two inputs, while Max unit 4558 outputs the larger of its two inputs. Both Min unit 4557 and Max unit 4558 may be implemented using one comparator and one 2:1 multiplexer.

The Max outputs of 2:2 sorters 4555, 4556 are wired to Min unit 4557, while the Min outputs of said 2:2 sorters are wired to Max unit 4558. This wiring assures that Min unit 4557 will output the second largest output of three-input adders 4551, 4552, 4553, 4554; while Min unit 4559 will output the second smallest output of said three-input adders. Said second largest and second smallest outputs may next be summed by adders 4559, to yield the median of YUL 4520, YUR 4521, YDL 4522 and YDR 4523 (FIG. 14) less the value of center pixel C, which is next added to the output of adder 4559 using adder 4560. The reader is noted that division by 2, done by ignoring the least significant bit and wiring the other bits right-shifted by 1, is not shown in the figures attached to this patent application.

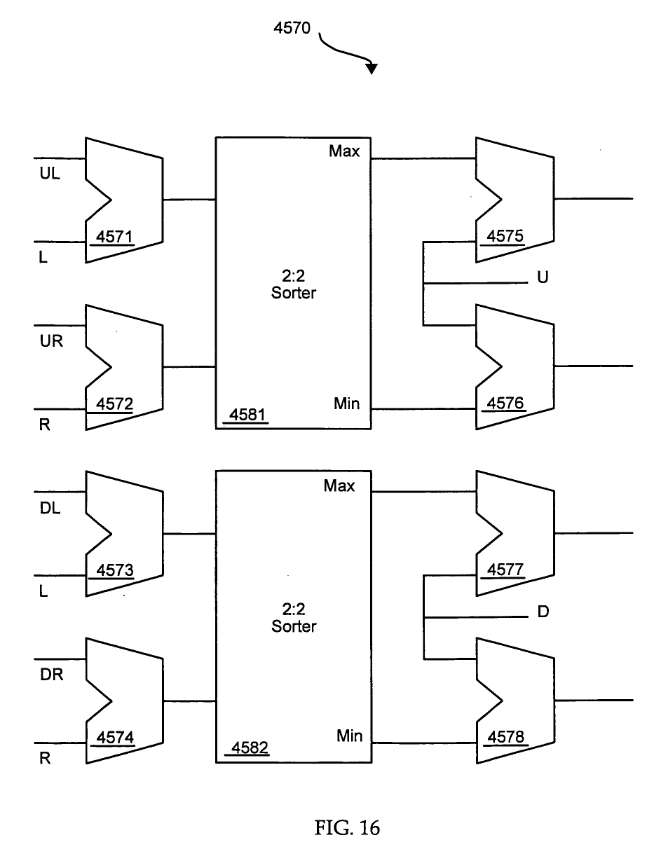

FIG. 16 depicts an alternative embodiment 4570 for segment 4565 of FIG. 15, designated Section A. 2-input adders only are used; and the addition of the U values to YUL, YUR; and the addition of the D value to YDL, YDR, are deferred to after the initial sort. Thus Adder 4571 calculates the value of YUL less C and less U, while Adder 4572 calculates the value of YUR less C and less U. The outputs of Adders 4571 and Adder 4572 are sorted by 2:2 sorter 4581, and the value of U is added to the sorted outputs, using adders 4555 and 4566, respectively. In a similar manner the addition of D is deferred until after YDL, YDR less D and C are added in adders 4573 and 4574, respectively; and sorted by Sorter 4582. As should be evident from trivial mathematics, outputs of Adders 4575 and, 4576 (FIG. 16) are identical Max and Min outputs of 2:2 sorter 4555 (FIG. 15), respectively. In a similar manner outputs of Adders 4577 and, 4578 (FIG. 16) are identical Max and Min outputs of 2:2 sorter 4556 (FIG. 15), respectively.

Having described several embodiments, it will be recognized by those of skill in the art that various modifications, alternative constructions, and equivalents may be used without departing from the spirit and scope of the invention. Additionally, a number of well known processes and elements have not been described in order to avoid unnecessarily obscuring the present invention. Accordingly, the above description should not be taken as limiting the scope of the invention, which is defined in the following claims.

What is claimed is:

1. A method for enhancing an image read from an image sensor in the digital domain, the method comprising steps of:
analyzing a row or a column of the image;
determining the row or column is defective;
replacing the row or the column with information from adjacent portions of the image when the row or image is found defective.

2. A method for enhancing an image read from an image sensor in the digital domain, the method comprising steps of:
determining first columns read from one side of the image sensor;
determining second columns read from an opposite side of the image sensor;
applying a first correction to the first columns, whereby variance through the column is addressed in the digital domain for the first columns; and
applying a second correction to the second columns, whereby variance through the column is addressed in the digital domain for the second columns.

3. A method for enhancing an image read from an image sensor in the digital domain, the method comprising steps of:
reading a red-green row or column from the image sensor, wherein the red-green row or column is part of a Bayer image;
discarding the red-green row or column from the Bayer image; and
processing the image by beginning with a green-blue row or column.

4. A method for enhancing an image from an image sensor, the method comprising steps of:
performing a horizontal interpolated RGB function;
performing a vertical interpolated RGB function;
determining if a portion of the image has a vertical edge or a horizontal edge; and
choosing either the horizontal interpolated RGB function or the vertical interpolated RGB function based upon the determining step.

5. A method for enhancing an image from an image sensor, the method comprising steps of:
gamma correcting a first image in the Bayer domain to produce a second image;
demosaicing the second image to produce a third image; and
inverse-gamma correcting the third image to produce a fourth image.

6. The method of claim 5, further comprising a step of sharpening the third image before the inverse-gamma correcting step.

7. A method for enhancing an image from an image sensor, the method comprising steps of:
gathering a matrix of green pixels in the Bayer domain;
determining if a periodic pattern appears in the matrix;
correcting green disparity according to the periodic pattern, wherein the correcting step is performed during normal operation of the image sensor.

8. A method for enhancing an image from an image sensor, the method comprising steps of:
providing a RGB vector;
categorizing a CMY color wheel into a plurality of slices, wherein each slice has a color correction matrix;
determining which slice corresponds to the RGB vector; and
applying the color correction matrix for the slice corresponding to the RGB vector.

9. A method for enhancing an image from an image sensor, the method comprising steps of:
analyzing a cluster of pixels in the image;
determining the cluster is defective in some way;
replacing the cluster with information from adjacent portions of the image when the cluster is found defective.

10. An image processing method for correcting photo response non-uniformity in an image sensor, comprising the steps of:
storing an approximation function of the photo response non-uniformity across the image sensor; and
using the approximation function to calculate corrections factors to correct the photo response non-uniformity of the image sensor.

11. The image processing method for correcting the photo response non-uniformity in the image sensor as recited in claim 10, wherein:
the approximation function is a 2-dimensional polynomial of the nth order.

12. The image processing method for correcting the photo response non-uniformity in the image sensor as recited in claim 11, wherein:
the approximation function is a 2-dimensional polynomial of the 3rd order.

13. The image processing method for correcting the photo response non-uniformity in the image sensor as recited in claim 10, further comprising:
scanning the image sensor in a known order; and
iteratively calculating the correction factors across the image sensor.

14. A method for enhancing an image from an image sensor, the method comprising steps of:
determining if a pixel is unusually hot or cold in comparison to neighboring pixels;
discarding the pixel based upon an outcome of the determining step; and
determining a replacement pixel for the pixel based upon an outcome of the determining step.
